(19) United States
(12) Patent Application Publication
(10) Pub. No.: US 2025/0086003 A1
(43) Pub. Date: Mar. 13, 2025

(54) COMPUTER-READABLE RECORDING MEDIUM STORING CONTROL PROGRAM, SYSTEM, AND CONTROL METHOD

(71) Applicant: Fujitsu Limited, Kawasaki-shi, Kanagawa (JP)

(72) Inventor: Masahiro MIWA, Ageo (JP)

(73) Assignee: Fujitsu Limited, Kawasaki-shi, Kanagawa (JP)

(21) Appl. No.: 18/823,167

(22) Filed: Sep. 3, 2024

(30) Foreign Application Priority Data
Sep. 11, 2023 (JP) 2023-146699

(51) Int. Cl. G06F 9/48; G06F 9/50

(52) U.S. Cl. CPC G06F 9/485; G06F 9/5027

(57) ABSTRACT

A recording medium stores a program for causing a computer to execute a process including: predicting based on completion time of a certain number of times of iteration obtained from an application that executes iterative processing and a total number of times of iteration, predicted completion time for a case where the iterative processing is executed as many times as the total number of times of iteration; comparing the predicted completion time with a time limit specified by a user; based on a comparison result, causing the application to output a checkpoint, and after execution of the application is stopped, performing a configuration change of resources for an information processing device that is used for execution of the application by using a resource pool; and restarting the application in the information processing device for which the configuration change has been performed, and resuming execution from the output checkpoint.

### CROSS-REFERENCE TO RELATED APPLICATION

This application is based upon and claims the benefit of priority of the prior Japanese Patent Application No. 2023-146699, filed on Sep. 11, 2023, the entire contents of which are incorporated herein by reference.

### FIELD

The embodiment discussed herein is related to a computer-readable recording medium storing a control program and the like.

### BACKGROUND

In recent years, a disaggregated architecture is known in which resources are flexibly configured beyond a frame of a server according to a use case. Resources referred to herein refer to a central processing unit (CPU), a graphics processing unit (GPU), a storage, a network, an operating system (OS), software, and the like, which are used when a system is constructed.

Japanese National Publication of International Patent Application No. 2019-511051, Japanese National Publication of International Patent Application No. 2017-527893, U.S. Patent Application Publication No. 2018/0102982, and U.S. Patent Application Publication No. 2018/0032360 are disclosed as related art.

However, the disaggregated architecture has a problem that there is a case where the resource pool may not be efficiently used.

### SUMMARY

According to an aspect of the embodiments, a non-transitory computer-readable recording medium stores a control program for causing a computer to execute a process including: predicting, in execution of an application in a system that includes a resource pool, based on completion time of a certain number of times of iteration obtained from the application that executes iterative processing and a total number of times of iteration, predicted completion time for a case where the iterative processing is executed as many times as the total number of times of iteration; comparing the predicted completion time with a time limit specified by a user; based on a comparison result, causing the application to output a checkpoint, and after execution of the application is stopped, performing a configuration change of resources for an information processing device that is used for execution of the application by using the resource pool; and restarting the application in the information processing device for which the configuration change has been performed, and resuming execution from the output checkpoint.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a configuration of a system according to an embodiment;

FIG. 2 is a diagram illustrating an example of a flow of control processing according to the embodiment;

FIG. 3 is a diagram illustrating an example of a functional configuration of a server according to the embodiment;

FIG. 4 is a diagram illustrating an example of the control processing according to the embodiment (a case of being within a time limit);

FIG. 5 is a diagram illustrating an example of the control processing according to the embodiment (a case of being over a time limit);

FIG. 6 is a diagram illustrating an example of the control processing according to the embodiment (a case of removal);

FIG. 7A is a diagram illustrating an example of a sequence of the control processing according to the embodiment (1);

FIG. 7B is a diagram illustrating an example of a sequence of the control processing according to the embodiment (2);

FIG. 8 is a diagram illustrating an example of a sequence of resource addition and resumption processing according to the embodiment;

FIG. 9 is a diagram illustrating an example of a sequence of resource removal and resumption processing according to the embodiment; and

FIG. 10 is a diagram illustrating an example of a computer that executes a control program.

### DESCRIPTION OF EMBODIMENTS

Such disaggregated architecture enables a configuration change such as addition of a resource to a server, by pooling resources, coupling the resource pool by a high-speed interconnect (for example, a Peripheral Component Interconnect-Express (PCIe) switch), and switching the coupling relationship of a switch. The disaggregated architecture may reduce the construction cost of a system as compared with a case where, for example, a GPU or the like is mounted in all servers.

For example, in the disaggregated architecture, a resource in the resource pool may not be allocated to a server that truly has to use the resource. For example, a method is conceivable in which a resource is allocated to a server in response to a request from a user, but such method may fail to appropriately allocate a resource. As an example, in a case where a GPU is allocated in response to a request from a user, there is a case where the processing speed of a server is sufficiently high by a CPU alone, or there is a case where the server does not use the allocated GPU for execution in the first place.

In the disaggregated architecture, even when a system supports addition and removal of a resource in operation, there is a case where dynamic addition and removal may not be performed during the operation of an application. For example, whether a resource has to be used is determined after an application is executed, and when it is determined that the resource has to be used, a device is added. However, since the application may not recognize the added device when the device is added while the application is being executed, the device may not be used. In a case where there is an application that is using a device coupled by a configuration change, when the device is removed while the application is being executed, kernel panic may occur and the system may be stopped.

In one aspect, an object of the present disclosure is to efficiently use a resource pool in a disaggregated architecture.

An embodiment of a control program, a system, and a control method disclosed in the present application will be described in detail below with reference to the drawings. The present disclosure is not limited by the embodiment.

### Embodiment

### [Configuration of System]

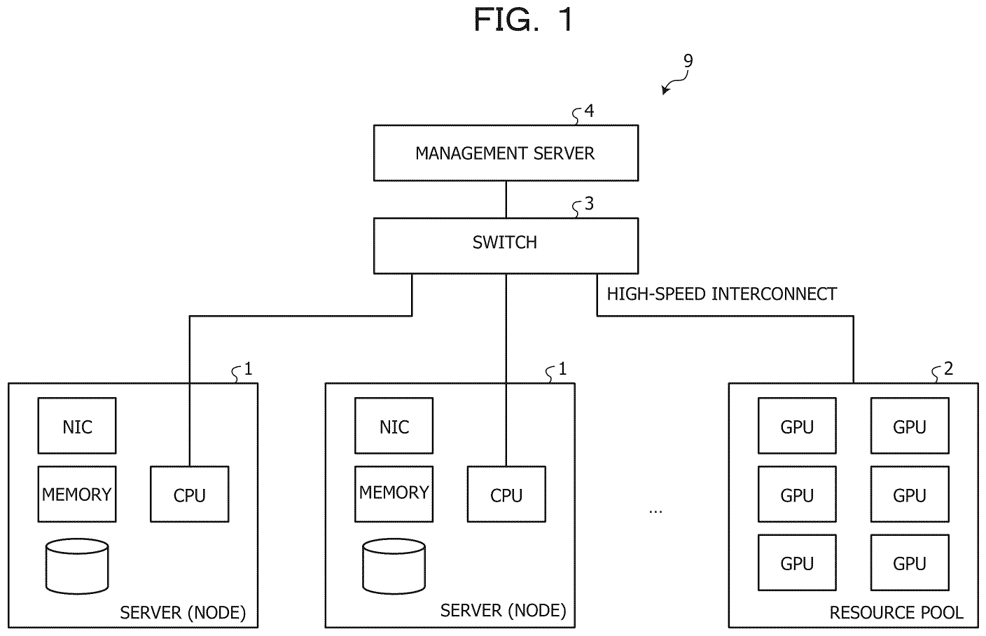

FIG. 1 is a block diagram illustrating an example of a configuration of the system according to the embodiment. A system 9 illustrated in FIG. 1 includes a plurality of servers 1, a resource pool 2, a switch 3, and a management server 4. The system 9 is a system having a configuration including a disaggregated architecture. Such disaggregated architecture enables a configuration change such as addition of a resource to the server 1, by pooling resources, coupling the resource pool 2 by the switch 3, and switching the coupling relationship of the switch 3.

The resource pool 2 pools resources. The resources in this example are GPUs, but this is not the only case. Resources may include a CPU, a storage, a network, an OS, software, and the like that are used to construct the system 9.

The management server 4 adds a resource in the resource pool 2 to the server 1 and removes a resource in the resource pool 2 added to the server 1. For example, the management server 4 performs a configuration change of adding a resource to the server 1 or removing a resource from the server 1 in accordance with an instruction from the server 1. A configuration change may be performed by switching the path of the switch 3 disposed between the resource pool 2 and the server 1. For example, the switch 3 is a PCIe switch that is a high-speed interconnect.

The server 1 includes a CPU, a memory, a storage, and a network interface card (NIC). The server 1 executes a target application under the control of a control process.

The target application will be described. The target application performs iterative processing by a loop. For example, an application that performs iterative processing is an application that performs learning processing of deep learning (DL). In such learning processing, one unit for processing the entire learning data is referred to as an epoch, and learning is advanced by executing this epoch as many times as a certain number of times of iteration. In the embodiment, the target application is described as learning processing.

The target application is an application that may use a resource to be added. For example, the target application may be executed not only by a CPU but also by a GPU. A GPU may be used when the GPU is coupled, and a CPU may be used when a GPU is not coupled.

The target application is an application that supports a checkpoint. A checkpoint refers to a mechanism in which, in an application having a relatively long execution time, even when execution of a job is stopped, the execution may be resumed from a result obtained in the middle of the execution at the time of the stopping by outputting, to a disk, the result obtained in the middle of execution of a certain iteration or step. In the embodiment, such checkpoint is used.

The target application is executed under the control of the control process. The control process predicts, based on the completion time of a certain number of times of iteration obtained from the target application and the total number of times of iteration of iterative processing, time (predicted completion time) predicted to be taken for completion when the iterative processing is executed as many times as the total number of times of iteration. The control process compares the predicted completion time with a time limit desired by a user, and when the predicted completion time does not satisfy the time limit, causes the target application to output a checkpoint and stops the execution of the target application. After the execution of the target application is stopped, the control process performs a configuration change of resources for the server 1 by using the resource pool 2. For example, the control process instructs the management server 4 to make a configuration change of adding a GPU, and the management server 4 makes the configuration change by controlling the path of the switch 3. When the predicted completion time satisfies the time limit and when a resource has been added and the predicted completion time is well shorter than the time limit, the control process causes the target application to output a checkpoint and stops the execution of the target application. After the execution of the target application is stopped, the control process performs a configuration change of resources for the server 1 by using the resource pool 2. For example, the control process instructs the management server 4 to make a configuration change of removing a GPU, and the management server 4 makes the configuration change by controlling the path of the switch 3. The control process restarts the target application in the server 1 for which the configuration change has been made, and resumes the execution from the output checkpoint.

### [Flow of Control Processing]

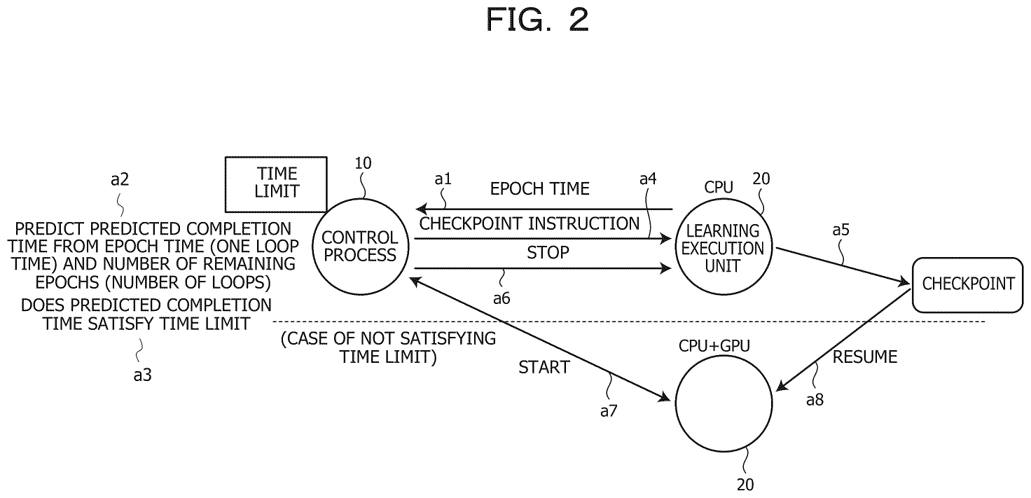

A flow of control processing performed by the control process will be described with reference to FIG. 2. FIG. 2 is a diagram illustrating an example of a flow of control processing according to the embodiment. In FIG. 2, the target application is learning processing of DL. A learning execution unit 20 including the learning processing uses a CPU in an initial state.

As illustrated in FIG. 2, the control process 10 acquires completion time of one epoch from the learning execution unit 20 executed by a CPU (a1). The control process 10 predicts predicted completion time for a case where the learning processing is executed as many times as the total number of epochs, based on the completion time of one epoch and the number of remaining epochs (the remaining number of times of iteration) (a2). The control process 10 compares the predicted completion time with a time limit specified by a user, and determines whether the predicted completion time satisfies the time limit (a3).

When the predicted completion time does not satisfy the time limit, the control process 10 causes the learning execution unit 20 to output a checkpoint (a4, a5). The control process 10 stops the execution of the learning processing performed by the CPU (a6). The control process 10 instructs the management server 4 to make a configuration change of adding a GPU, and the management server 4 adds a GPU to the server 1 by controlling the path of the switch 3.

The control process 10 starts the learning processing with the configuration in which a GPU is added to the server 1 (a7), and resumes the execution from the output checkpoint (a8). For example, learning processing may be executed using a GPU.

Accordingly, the system 9 may allocate a resource in the resource pool 2 to the server 1 that truly has to use the resource. Even during the operation of the target learning processing, the system 9 may reliably add or remove a resource. For example, since the target learning processing is temporarily stopped when a resource is added, and is resumed after a resource is added or removed, the added resource may be recognized. As a result, the system 9 may reliably add or remove a resource.

### [Functional Configuration of Server]

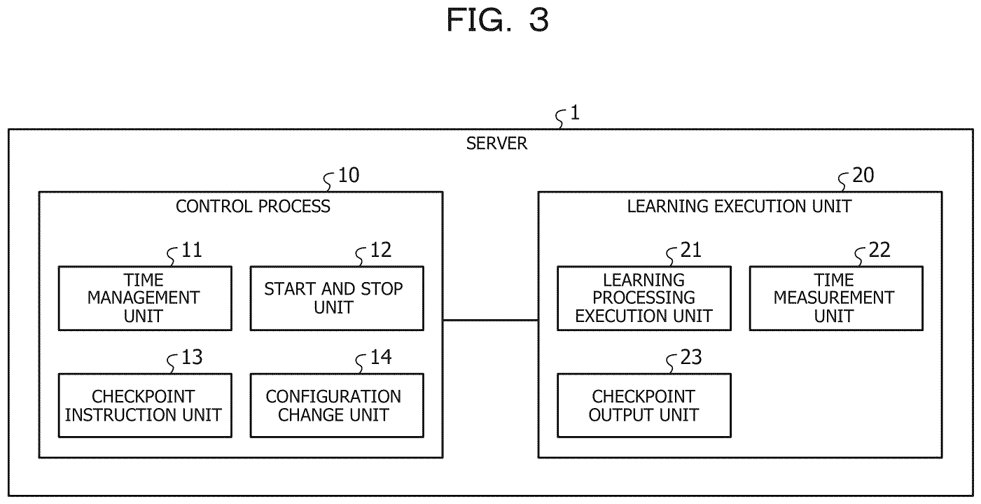

FIG. 3 is a diagram illustrating an example of a functional configuration of the server according to the embodiment. As illustrated in FIG. 3, the server 1 includes the control process 10 and the learning execution unit 20. The control process 10 includes a time management unit 11, a start and stop unit 12, a checkpoint instruction unit 13, and a configuration change unit 14. The learning execution unit 20 includes a learning processing execution unit 21, a time measurement unit 22, and a checkpoint output unit 23. The time management unit 11 is an example of a prediction unit and a comparison unit. The start and stop unit 12, the checkpoint instruction unit 13, and the configuration change unit 14 are examples of a performing unit. The start and stop unit 12 is an example of a resumption unit.

The time management unit 11 manages time of learning execution. For example, the time management unit 11 receives a time limit specified by a user and the remaining number of times of iteration. The time management unit 11 acquires, from the learning execution unit 20, time taken for a certain iteration of learning processing. As an example, the time management unit 11 acquires time taken for one epoch and the remaining number of times of iteration. The time management unit 11 predicts predicted completion time as in the following formula (1) based on the time taken for a certain iteration of learning processing and the remaining number of times of iteration of learning processing. For example, iteration time refers to time taken for one iteration of learning processing. Predicted completion time=(elapsed time up to this point)+(iteration time×remaining number of times of iteration) . . . formula (1)

The time management unit 11 compares the predicted completion time with the time limit, and executes the following processing based on the comparison result. When the predicted completion time does not satisfy the time limit, the time management unit 11 performs the following processing to add a resource. The time management unit 11 causes the checkpoint instruction unit 13 to give an instruction to output a checkpoint. The time management unit 11 causes the start and stop unit 12 to stop the learning processing. After the learning processing is stopped, the time management unit 11 causes the configuration change unit 14 to make a configuration change so as to add a resource. The time management unit 11 instructs the start and stop unit 12 to cause the learning execution unit 20 to resume the learning processing from the checkpoint.

When the predicted completion time satisfies the time limit and when a resource has been added and the predicted completion time is well shorter than the time limit, the time management unit 11 performs the following processing to remove the resource. The time management unit 11 causes the checkpoint instruction unit 13 to give an instruction to output a checkpoint. The time management unit 11 causes the start and stop unit 12 to stop the learning processing. After the learning processing is stopped, the time management unit 11 causes the configuration change unit 14 to make a configuration change so as to remove the added resource. The time management unit 11 instructs the start and stop unit 12 to cause the learning execution unit 20 to resume the learning processing from the checkpoint.

The start and stop unit 12 starts or stops learning processing based on an instruction of the time management unit 11. For example, when an instruction to stop learning processing is received from the time management unit 11, the start and stop unit 12 stops the learning processing currently being executed in the learning execution unit 20. When an instruction to start learning processing is received from the time management unit 11, the start and stop unit 12 starts the learning processing in the learning execution unit 20.

The checkpoint instruction unit 13 instructs to output a checkpoint based on an instruction of the time management unit 11. For example, when a checkpoint instruction is received from the time management unit 11, the checkpoint instruction unit 13 causes the learning processing in the learning execution unit 20 to output a checkpoint.

The configuration change unit 14 instructs to make a configuration change of resources based on an instruction of the time management unit 11. For example, when addition of a resource is received from the time management unit 11, the configuration change unit 14 instructs the management server 4 to add the resource to the server 1 being used for learning processing. When removal of a resource is received from the time management unit 11, the configuration change unit 14 instructs the management server 4 to remove the resource from the server 1 being used for learning processing.

The learning processing execution unit 21 executes learning processing under the control of the control process 10. For example, when a request to start learning processing is received from the control process 10, the learning processing execution unit 21 resumes the learning processing from a checkpoint when there is the checkpoint, and executes the learning processing from the beginning when there is no checkpoint. When a request to stop learning processing is received from the control process 10, the learning processing execution unit 21 stops the learning processing.

The time measurement unit 22 measures time of learning execution. For example, the time measurement unit 22 measures time taken for one iteration of learning processing each time. As an example, the time measurement unit 22 measures completion time of each epoch for each epoch.

The checkpoint output unit 23 outputs a checkpoint. For example, when a request for outputting a checkpoint of learning processing is received from the control process 10, the checkpoint output unit 23 outputs a checkpoint of learning processing.

### Examples of Control Processing

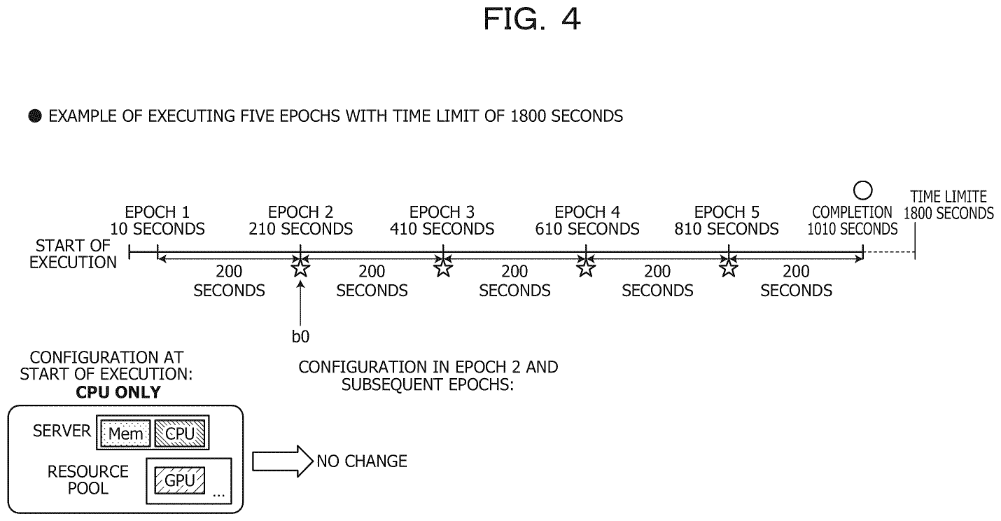

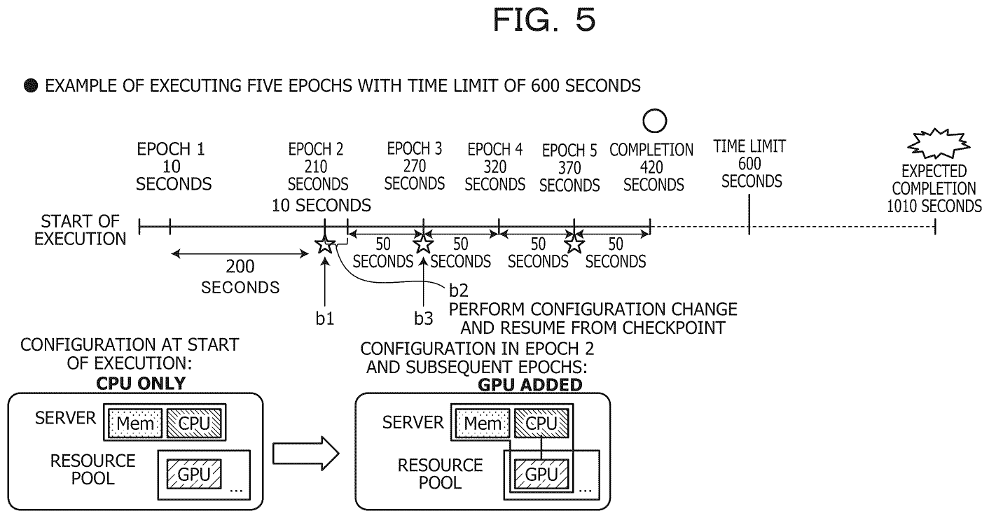

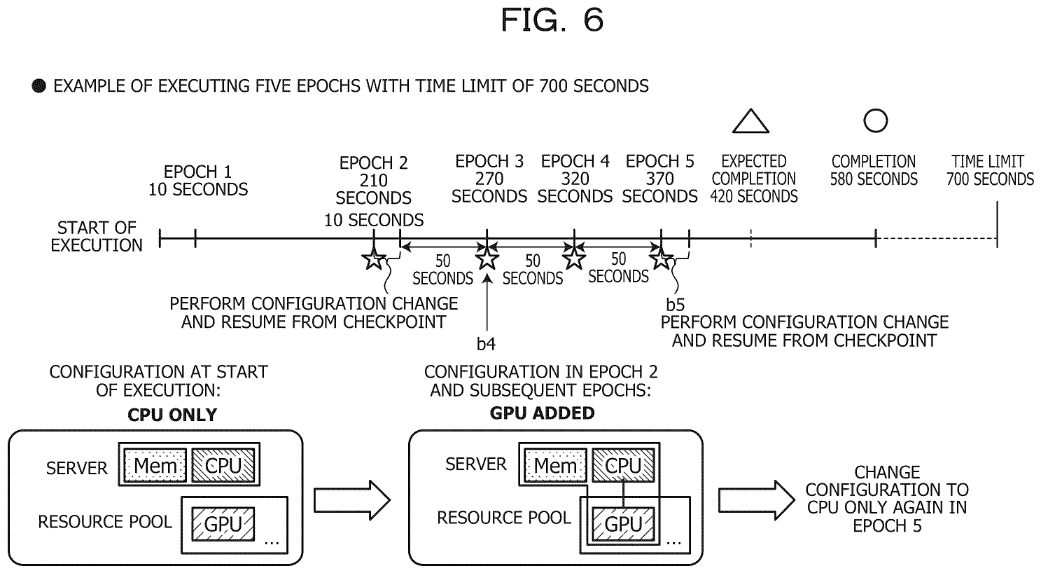

Examples of the control processing according to the embodiment will be described with reference to FIGS. 4 to 6. FIGS. 4 to 6 are diagrams illustrating examples of the control processing according to the embodiment. In FIG. 4, a case of being within a time limit will be described. In FIG. 5, a case of being over a time limit will be described. In FIG. 6, a case of removal will be described.

FIG. 4 is a diagram illustrating an example of the control processing according to the embodiment (the case of being within a time limit). As illustrated in FIG. 4, five epochs of learning processing are executed and the time limit is 1800 seconds. The system 9 has a configuration at the start of execution of the learning processing in which the server 1 includes a CPU and a memory, and the resource pool 2 includes GPUs. Determination by the control process 10 at the time point (b0) when epoch “1” is completed will be described.

As illustrated in FIG. 4, the time management unit 11 acquires, from the learning execution unit 20, time taken for one epoch and the remaining number of times of iteration. “200 seconds” is acquired as the time taken for one epoch (iteration time). “4” is acquired as the remaining number of times of iteration. Elapsed time up to this point is the elapsed time for completion of epoch “1”, which is “210 seconds”.

The time management unit 11 predicts predicted completion time by using formula (1). The predicted completion time is predicted to be 1010 (=210+200×4) seconds. For example, it takes “200 seconds” for one iteration (epoch), and it takes “210 seconds” from the start of execution to completion of one epoch. Since it takes 800 (=200×4) seconds for the remaining four epochs, the predicted completion time is predicted to be “1010 seconds”.

The time management unit 11 compares the predicted completion time with the time limit, and determines whether the predicted completion time satisfies the time limit. Since the predicted completion time is “1010 seconds” and the time limit is “1800 seconds”, it is determined that the predicted completion time satisfies the time limit. As a result, it is determined that there is no change in the configuration of the server 1 in epoch 2 and subsequent epochs.

FIG. 5 is a diagram illustrating an example of the control processing according to the embodiment (the case of being over a time limit). As illustrated in FIG. 5, five epochs of learning processing are executed and the time limit is 600 seconds. The system 9 has a configuration at the start of execution of the learning processing in which the server 1 includes a CPU and a memory, and the resource pool 2 includes GPUs. Determination by the control process 10 at the time point (b1) when epoch “1” is completed will be described.

As illustrated in FIG. 5, the time management unit 11 acquires, from the learning execution unit 20, time taken for one epoch and the remaining number of times of iteration. “200 seconds” is acquired as the time taken for one epoch (iteration time). “4” is acquired as the remaining number of times of iteration. Elapsed time up to this point is the elapsed time from the start of execution to completion of epoch “1”, which is “210 seconds”.

The time management unit 11 predicts predicted completion time by using formula (1). The predicted completion time is predicted to be 1010 (=210+200×4) seconds. For example, it takes “200 seconds” for one iteration (epoch), and it takes “210 seconds” from the start of execution to completion of one epoch. Since it takes 800 (=200×4) seconds for the remaining four epochs, the predicted completion time is predicted to be “1010 seconds”.

The time management unit 11 compares the predicted completion time with the time limit, and determines whether the predicted completion time satisfies the time limit. Since the predicted completion time is “1010 seconds” and the time limit is “600 seconds”, it is determined that the predicted completion time does not satisfy the time limit. For example, the processing may not be completed within the time limit in this state.

The time management unit 11 performs the following processing to satisfy the completion of the processing within the time limit. The time management unit 11 causes an instruction to output a checkpoint to be given to the learning execution unit 20, and causes the learning processing to be stopped. After the learning processing is stopped, the time management unit 11 causes the configuration change unit 14 to make a configuration change so as to add a resource. The time management unit 11 causes the learning execution unit 20 to start the learning processing and resume the learning processing from the checkpoint (b2). The configuration change unit 14 adds a GPU included in the resource pool 2 to the server 1 based on an instruction of the time management unit 11. As a result, in epoch 2 and subsequent epochs, a GPU is included in the server 1 in addition to the CPU and the memory. The CPU is newly coupled to a GPU in the resource pool 2, and the learning processing is executed using the GPU.

Determination by the control process 10 at the time point (b3) when epoch “2” is completed is as follows. The time management unit 11 acquires, from the learning execution unit 20, time taken for one epoch and the remaining number of times of iteration. “50 seconds” is acquired as the time taken for the latest one epoch (iteration time). “3” is acquired as the remaining number of times of iteration. Elapsed time up to this point is the elapsed time from the start of execution to completion of epoch “2”, which is “270 seconds”.

The time management unit 11 predicts predicted completion time by using formula (1). The predicted completion time is predicted to be 420 (=270+50×3) seconds. For example, it takes “50 seconds” for one most recent iteration (epoch), and it takes “270 seconds” from the start of execution to completion of one epoch. Since it takes 150 (=50×3) seconds for the remaining three epochs, the predicted completion time is predicted to be “420 seconds”.

The time management unit 11 compares the predicted completion time with the time limit, and determines whether the predicted completion time satisfies the time limit. Since the predicted completion time is “420 seconds” and the time limit is “600 seconds”, it is determined that the predicted completion time satisfies the time limit. As a result, it is determined that there is no change in the configuration in epoch 3 and subsequent epochs.

Accordingly, the control process 10 may efficiently use the resource pool 2 in a disaggregated architecture.

FIG. 6 is a diagram illustrating an example of the control processing according to the embodiment (a case of removal). As illustrated in FIG. 6, five epochs of learning processing are executed and the time limit is 700 seconds. The configuration of the server 1 at the start of execution of the learning processing is CPU only, and a GPU is added to the CPU at the time point when epoch “1” is completed. Determination by the control process 10 at the time point (b4) when epoch “2” is completed will be described.

As illustrated in FIG. 6, the time management unit 11 acquires, from the learning execution unit 20, time taken for one epoch and the remaining number of times of iteration. “50 seconds” is acquired as the time taken for one epoch (iteration time). “3” is acquired as the remaining number of times of iteration. Elapsed time up to this point is the elapsed time from the start of execution to completion of epoch “2”, which is “270 seconds”.

The time management unit 11 predicts predicted completion time by using formula (1). The predicted completion time is predicted to be 420 (=270+50×3) seconds. For example, it takes “50 seconds” for one most recent iteration (epoch), and it takes “270 seconds” from the start of execution to completion of one epoch. Since it takes 150 (=50×3) seconds for the remaining three epochs, the predicted completion time is predicted to be “420 seconds”.

The time management unit 11 compares the predicted completion time with the time limit, and determines whether the predicted completion time satisfies the time limit. Since the predicted completion time is “420 seconds” and the time limit is “700 seconds”, it is determined that the predicted completion time satisfies the time limit. When the predicted completion time satisfies the time limit, the time management unit 11 determines whether a resource has been added and the predicted completion time is well shorter than the time limit. The difference between the predicted completion time and the time limit is “280 seconds” (=700−420). Before the GPU is added to the server 1, the execution time for one epoch is “200 seconds”. On the other hand, after the GPU is added to the server 1, the execution time for one epoch is “50 seconds”. “280”, which is the difference between the predicted completion time and the time limit, divided by the remaining time in a case where the last one epoch is assumed to be executed only by the CPU (200−50), is calculated to be 1.86, which is larger than 1. Therefore, it is determined that the time is within the time limit even when it takes “150 seconds” (=200−50) longer in the last one epoch in the case where the epoch is assumed to be executed only by the CPU. For example, the time management unit 11 determines that the predicted completion time is well shorter than the time limit.

At the time point of one epoch remaining, the time management unit 11 performs the following processing to remove the resource. The time management unit 11 causes an instruction to output a checkpoint to be given to the learning execution unit 20, and causes the learning processing to be stopped. After the learning processing is stopped, the time management unit 11 causes the configuration change unit 14 to make a configuration change so as to remove the added resource. The time management unit 11 causes the learning execution unit 20 to start the learning processing and resume the learning processing from the checkpoint. The configuration change unit 14 removes the GPU included in the resource pool 2 from the server 1 based on an instruction of the time management unit 11. As a result, in the last epoch 5, the configuration of the server 1 is changed to CPU only again. The resource is removed in the last epoch to minimize the number of times that a resource is removed or added.

Accordingly, the control process 10 may efficiently use the resource pool 2 in a disaggregated architecture.

### [Sequence of Control Processing]

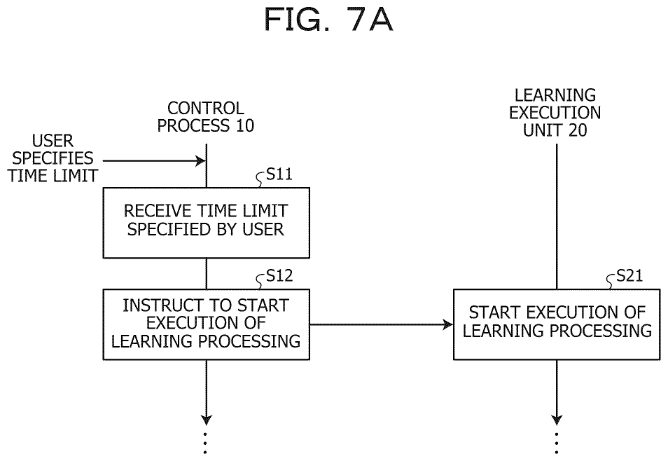

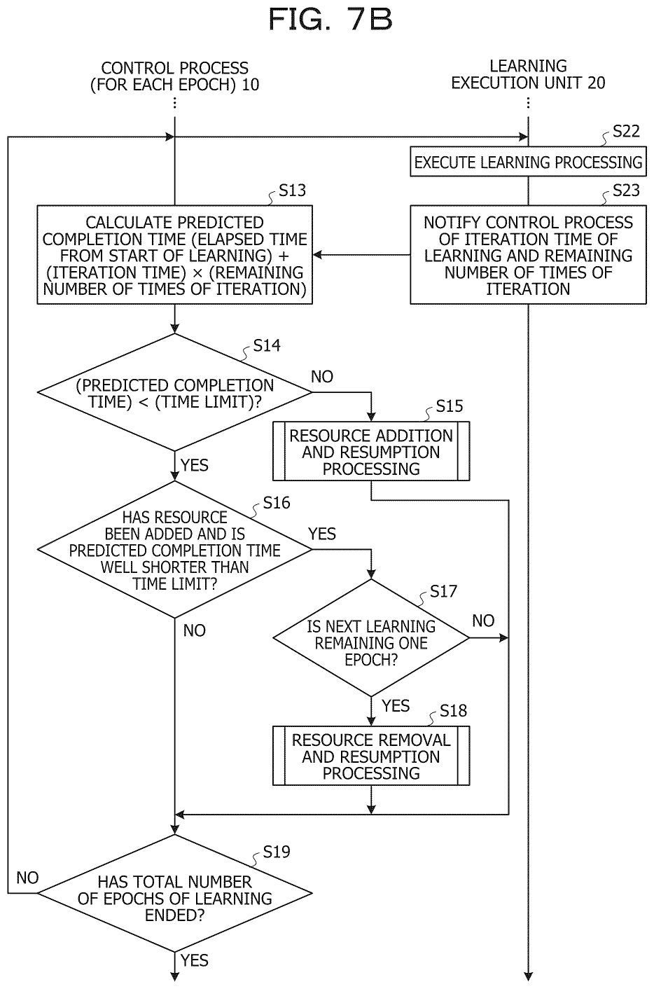

An example of a sequence of the control processing according to the embodiment will be described with reference to FIGS. 7A and 7B. FIGS. 7A and 7B are diagrams illustrating an example of a sequence of the control processing according to the embodiment.

As illustrated in FIG. 7A, the control process 10 receives a time limit for learning processing specified by a user (step S11). The control process 10 instructs the learning execution unit 20 to start the execution of the learning processing (step S12).

The learning execution unit 20 that has received the instruction to start the execution of the learning processing from the control process 10 starts the execution of the learning processing (step S21).

As illustrated in FIG. 7B, the learning execution unit 20 executes the learning processing (step S22). The learning processing is performed for each epoch. The learning execution unit 20 notifies the control process 10 of the iteration time of one epoch of the learning processing and the remaining number of times of iteration (step S23). Iteration time refers to time taken for one epoch of learning processing.

The control process 10 that has received the notification from the learning execution unit 20 performs the following processing for each epoch. The control process 10 calculates predicted completion time obtained by adding (iteration time×remaining number of times of iteration) to elapsed time from the start of learning (step S13). The control process 10 determines whether the predicted completion time is shorter than the time limit (step S14). For example, the control process 10 determines whether the predicted completion time satisfies the time limit.

When it is determined that the predicted completion time is equal to or longer than the time limit (No in step S14), the control process 10 executes resource addition and resumption processing (step S15). For example, this is a case where the predicted completion time does not satisfy the time limit. A flowchart of the resource addition and resumption processing will be described later. The control process 10 proceeds to step S19.

On the other hand, when it is determined that the predicted completion time is shorter than the time limit (Yes in step S14), the control process 10 determines whether a resource has been added and the predicted completion time is well shorter than the time limit (step S16). For example, this is a case where the predicted completion time satisfies the time limit. When it is determined that a resource has been added and the predicted completion time is not well shorter than the time limit (No in step S16), the control process 10 proceeds to step S19 without changing the configuration of resources.

On the other hand, when it is determined that a resource has been added and the predicted completion time is well shorter than the time limit (Yes in step S16), the control process 10 determines whether the next learning processing is the remaining one epoch (step S17). When it is determined that the next learning processing is not the remaining one epoch (No in step S17), the control process 10 proceeds to step S19 without changing the configuration of resources.

On the other hand, when it is determined that the next learning processing is the remaining one epoch (Yes in step S17), the control process 10 executes resource removal and resumption processing (step S18). A flowchart of the resource removal and resumption processing will be described later. The control process 10 proceeds to step S19.

In step S19, the control process 10 determines whether the total number of epochs of learning processing has ended (step S19). When it is determined that the total number of epochs of learning processing has not ended (No in step S19), the control process 10 proceeds to the next epoch of learning processing.

On the other hand, when it is determined that the total number of epochs of learning processing has ended (Yes in step S19), the control process 10 ends the control process processing.

### [Sequence of Resource Addition and Resumption Processing]

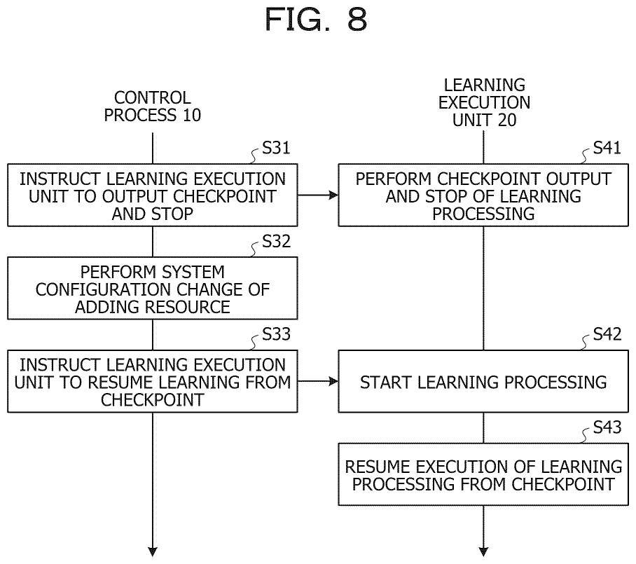

FIG. 8 is a diagram illustrating an example of a sequence of resource addition and resumption processing according to the embodiment. As illustrated in FIG. 8, the control process 10 instructs the learning execution unit 20 to output a checkpoint and stop learning processing (step S31). The learning execution unit 20 outputs a checkpoint of the learning processing. After the checkpoint is output, the learning execution unit 20 stops the learning processing (step S41).

After the learning processing is stopped, the control process 10 performs a system configuration change of adding a resource (step S32). For example, the control process 10 instructs the management server 4 to add a resource to the server 1 used for the learning processing, and the management server 4 adds the resource to the server 1 by controlling the path of the switch 3.

After the resource is added, the control process 10 instructs the learning execution unit 20 to resume learning from the checkpoint (step S33). The learning execution unit 20 starts the learning processing using the added system configuration (step S42). The learning execution unit 20 resumes the execution of learning processing from the checkpoint (step S43).

### [Sequence of Resource Removal and Resumption Processing]

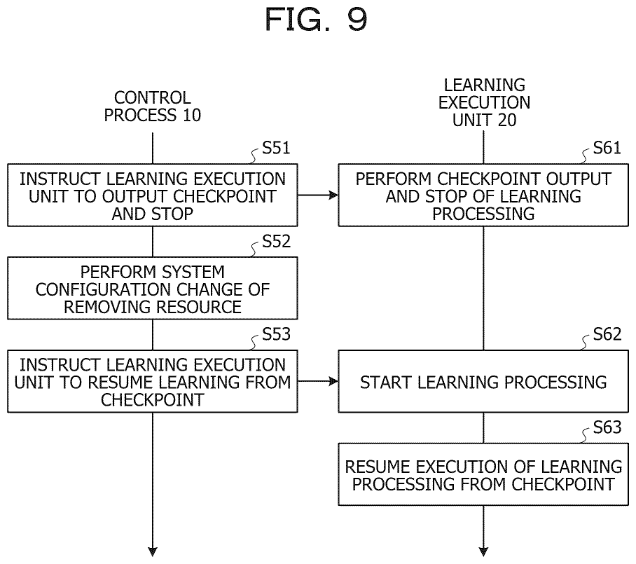

FIG. 9 is a diagram illustrating an example of a sequence of resource removal and resumption processing according to the embodiment. As illustrated in FIG. 9, the control process 10 instructs the learning execution unit 20 to output a checkpoint and stop learning processing (step S51). The learning execution unit 20 outputs a checkpoint of the learning processing. After the checkpoint is output, the learning execution unit 20 stops the learning processing (step S61).

After the learning processing is stopped, the control process 10 performs a system configuration change of removing a resource (step S52). For example, the control process 10 instructs the management server 4 to remove a resource from the server 1 used for the learning processing, and the management server 4 removes the resource from the server 1 by controlling the path of the switch 3.

After the resource is removed, the control process 10 instructs the learning execution unit 20 to resume learning from the checkpoint (step S53). The learning execution unit 20 starts the learning processing using the removed system configuration (step S62). The learning execution unit 20 resumes the execution of learning processing from the checkpoint (step S63).

The control process 10 predicts predicted completion time based on the time taken for a certain iteration of learning processing and the remaining number of times of iteration of learning processing. In the embodiment, a certain iteration of learning processing has been described as one epoch. However, the time taken for a certain iteration of learning processing is not limited to the time taken for one epoch, and may be the time taken for two epochs or the time taken for three epochs depending on the total number of times of iteration.

In the embodiment, the target application has been described as learning processing. However, the target application is not limited to learning processing, and may be any application as long as it performs iterative processing by a loop. For example, the target application may be an application that performs iterative processing by a loop that may be realized by a for statement, a while statement, or the like.

In the embodiment, the configuration of the system 9 at the start of execution is a configuration in which the server 1 does not use a resource in the resource pool 2. However, if there is enough amount of resources, a configuration may be employed in which a resource is allocated to the server 1 from the start of execution. For example, when (usage rate of server 1)/(usage rate of resources in resource pool 2) is equal to or larger than a predetermined ratio, the system 9 may determine that this is a case where there are many servers 1 to which a resource is not allocated and there is enough amount of resources. In such case, execution of the target application may be started after a resource is allocated to the server 1.

In the embodiment, it has been described that the server 1 uses a resource in the resource pool 2. There is a case where resources of the same type have a plurality of performance differences in the resource pool 2. In such case, the server 1 may select a resource to be used as follows. For example, in a case where the resource is a GPU, the system 9 acquires a benchmark in advance for each of a plurality of GPUs in the resource pool 2. The system 9 obtains an acceleration degree of a GPU with respect to the CPU mounted in the server 1, and generates a table in which each GPU and the acceleration degree are associated with each other. The server 1 may compare the predicted completion time for a case where the target application is executed by the CPU with a time limit specified by a user, obtain a ratio of the predicted completion time to the time limit when the predicted completion time does not satisfy the time limit, and select a GPU having an acceleration degree close to the ratio from the created table. As an example, in a case where the predicted completion time is five times the time limit, even when a GPU that is accelerated three times with respect to the CPU is selected, the predicted completion time may not satisfy the time limit. For this reason, the server 1 may select a GPU that is accelerated five times with respect to the CPU from a table generated in advance.

### Effects of Embodiment

According to the above embodiment, in the execution of an application in the system 9 including the resource pool 2, the server 1 predicts predicted completion time for a case where iterative processing is executed as many times as the total number of times of iteration based on the completion time of a certain number of times of iteration obtained from the application that executes the iterative processing and the total number of times of iteration. The server 1 compares the predicted completion time with a time limit specified by a user. Based on the comparison result, the server 1 causes the application to output a checkpoint, and after the execution of the application is stopped, performs a configuration change of resources for the server 1 being used for the execution of the application by using the resource pool. The server 1 restarts the application in the server 1 for which the configuration change has been performed, and resumes the execution from the output checkpoint. According to such configuration, the server 1 may efficiently use the resource pool 2. For example, the server 1 may use a resource to be used when the resource in the resource pool 2 truly has to be used. Additionally, the server 1 may dynamically and reliably use a resource in the resource pool 2 at a timing at which it is determined that the resource has to be used or at a timing at which it is determined that the resource does not have to be used.

According to the above embodiment, in the processing of performing a configuration change, when the predicted completion time does not satisfy the time limit, the server 1 causes the application to output a checkpoint, causes the execution of the application to be stopped, and performs addition of a resource to the server 1 by using the resource pool 2 after the execution of the application is stopped. According to such configuration, the server 1 may use a resource in the resource pool 2 from the application when the predicted completion time does not satisfy the time limit, and may accelerate the processing by using the resource.

According to the above embodiment, in the processing of performing a configuration change, when the predicted completion time satisfies the time limit and when a resource has been added and the predicted completion time is well shorter than the time limit, the server 1 causes the application to output a checkpoint, causes the execution of the application to be stopped, and performs removal of the added resource from the server 1 after the execution of the application is stopped. According to such configuration, the server 1 may remove a resource without an error since a resource in the resource pool 2 may be removed after the application is stopped, and the resource may be used in another application that has to use the resource.

According to the above embodiment, in the processing of predicting predicted completion time, the server 1 predicts the predicted completion time by using the elapsed time from the start of iterative processing, the completion time of a certain number of times of iteration, and the remaining number of times of iteration. According to such configuration, the server 1 may compare the predicted completion time with the time limit by predicting the predicted completion time, and may recognize an excess or deficiency of resources currently mounted in the server 1.

According to the above embodiment, in the processing of performing a configuration change, in a case where a resource is added to the server 1, the server 1 selects, from the resource pool 2, a resource having a performance ratio closest to the ratio of the predicted completion time to the time limit by using a table storing the performance ratio between the resource mounted in the server 1 in advance and a resource included in the resource pool 2, and adds the selected resource to the server 1. According to such configuration, the server 1 may reliably select, from the resource pool 2, a resource that enables the time to be within the time limit.

### [Others]

Each constituent element of the control process 10 or each constituent element of the learning execution unit 20 in the server 1 illustrated in the drawing does not have to be physically configured as illustrated in the drawing. For example, the specific form of distribution and integration of the control process 10 and the learning execution unit 20 in the server 1 is not limited to that illustrated in the drawing, and all or part thereof may be configured to be functionally or physically distributed or integrated in arbitrary units depending on various loads, usage states, and the like.

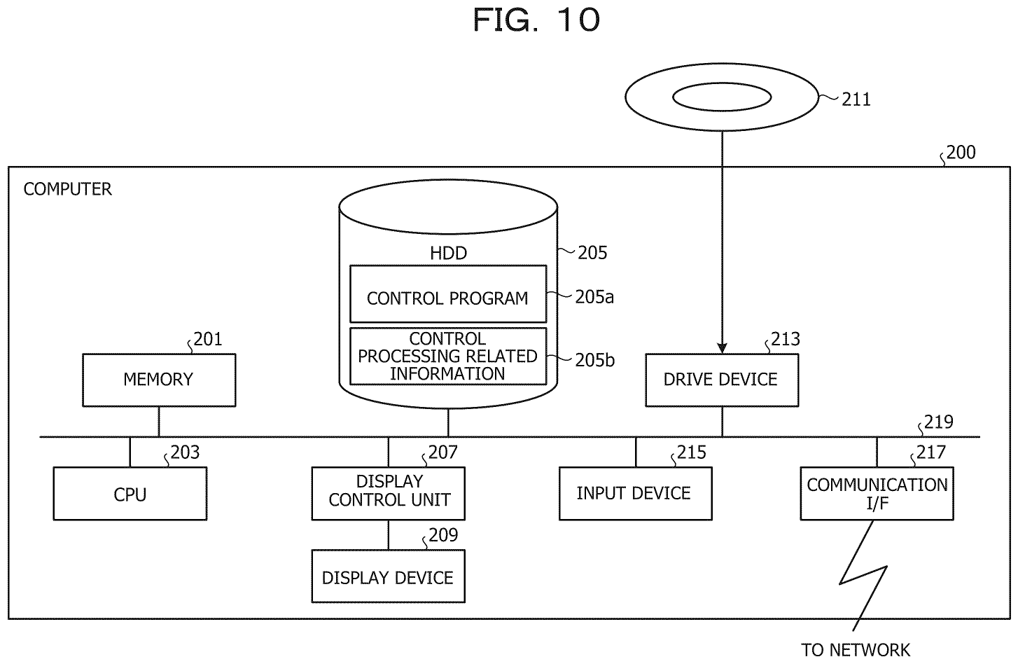

The various types of processing described in the above embodiment may be realized by executing, with a computer such as a personal computer or a workstation, a program prepared in advance. Hereinafter, description will be given for an example of a computer that executes a control program for realizing functions similar to those of the control process 10 and the learning execution unit 20 in the server 1 illustrated in FIG. 3. The control program for realizing functions similar to those of the control process 10 and the learning execution unit 20 in the server 1 will be described as an example. FIG. 10 is a diagram illustrating an example of a computer that executes the control program.

As illustrated in FIG. 10, a computer 200 includes a CPU 203 that executes various kinds of arithmetic processing, an input device 215 that receives input of data from a user, and a display device 209. The computer 200 includes a drive device 213 that reads a program or the like from a storage medium, and a communication interface (I/F) 217 that exchanges data with another computer via a network. The computer 200 includes a memory 201 that temporarily stores various kinds of information and a hard disk drive (HDD) 205. The memory 201, the CPU 203, the HDD 205, a display control unit 207, the display device 209, the drive device 213, the input device 215, and the communication I/F 217 are coupled by a bus 219.

For example, the drive device 213 is a device for a removable disk 211. The HDD 205 stores a control program 205a and control processing related information 205b. The communication I/F 217 serves as an interface between the network and the inside of the computer, and controls input and output of data from and to another computer. For example, a modem, a local area network (LAN) adapter, or the like may be used as the communication I/F 217.

The display device 209 is a display device that displays a cursor, icons or tool boxes, and data such as documents, images, and functional information. For example, a liquid crystal display, an organic electroluminescence (EL) display, or the like may be used as the display device 209.

The CPU 203 reads the control program 205a, loads the control program 205a to the memory 201, and executes the control program 205a as processes. Such processes correspond to the respective functional units of the server 1. For example, a file holding a checkpoint (not illustrated) or the like is included in the control processing related information 205b. For example, the removable disk 211 stores various kinds of information such as the control program 205a.

The control program 205a does not have to be stored in the HDD 205 from the beginning. For example, the program is stored in a “portable physical medium” to be inserted into the computer 200, such as a flexible disk (FD), a compact disc read-only memory (CD-ROM), a Digital Versatile Disc (DVD), a magneto-optical disk, or an integrated circuit (IC) card. The computer 200 may execute the control program 205a by reading the control program 205a from these media.

For example, the control processing performed by the server 1 described in the above embodiment may be applied to a system that adopts a disaggregated architecture.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a control program for causing a computer to execute a process comprising,
in execution of an application in a system that includes a resource pool:
predicting, based on completion time of a certain number of times of iteration obtained from the application that executes iterative processing and a total number of times of iteration, predicted completion time for a case where the iterative processing is executed as many times as the total number of times of iteration;
comparing the predicted completion time with a time limit specified by a user;
based on a comparison result, causing the application to output a checkpoint, and after execution of the application is stopped, performing a configuration change of resources for an information processing device that is used for execution of the application by using the resource pool; and
restarting the application in the information processing device for which the configuration change has been performed, and resuming execution from the output checkpoint.

2. The non-transitory computer-readable recording medium according to claim 1, wherein
when the predicted completion time does not satisfy the time limit, the performing of the configuration change causes the application to output a checkpoint, causes execution of the application to be stopped, and performs addition of a resource to the information processing device by using the resource pool after execution of the application is stopped.

3. The non-transitory computer-readable recording medium according to claim 1, wherein
when the predicted completion time satisfies the time limit and when the resource has been added and the predicted completion time is well shorter than the time limit, the performing of the configuration change causes the application to output a checkpoint, causes execution of the application to be stopped, and performs removal of the added resource from the information processing device after execution of the application is stopped.

4. The non-transitory computer-readable recording medium according to claim 1, wherein
the predicting of the predicted completion time predicts the predicted completion time by using elapsed time from start of the iterative processing, the completion time of a certain number of times of iteration, and a remaining number of times of iteration.

5. The non-transitory computer-readable recording medium according to claim 2, wherein
in a case where a resource is added to the information processing device, the performing of the configuration change selects, from the resource pool, a resource that has a performance ratio closest to a ratio of the predicted completion time to the time limit by using a table that stores a performance ratio between a resource mounted in the information processing device in advance and a resource included in the resource pool, and adds a selected resource to the information processing device.

6. A system comprising:
a resource pool; and
an information processing device that executes an application that performs iterative processing, wherein
the information processing device includes
a prediction unit that predicts, based on completion time of a certain number of times of iteration obtained from the application and a total number of times of iteration, predicted completion time for a case where the iterative processing is executed as many times as the total number of times of iteration,
a comparison unit that compares the predicted completion time with a time limit specified by a user,
a performing unit that, based on a comparison result, causes the application to output a checkpoint, and after execution of the application is stopped, performs a configuration change of resources for the information processing device by using the resource pool, and
a resumption unit that restarts the application in the information processing device and resumes execution from the output checkpoint.

7. A control method for causing a computer to execute a process comprising,
in execution of an application in a system that includes a resource pool:
predicting, based on completion time of a certain number of times of iteration obtained from the application that executes iterative processing and a total number of times of iteration, predicted completion time for a case where the iterative processing is executed as many times as the total number of times of iteration;
comparing the predicted completion time with a time limit specified by a user;
based on a comparison result, causing the application to output a checkpoint, and after execution of the application is stopped, performing a configuration change of resources for an information processing device that is used for execution of the application by using the resource pool; and
restarting the application in the information processing device for which the configuration change has been performed, and resuming execution from the output checkpoint.
